(19) United States
(12) Patent Application Publication
(10) Pub. No.: US 2022/0060455 A1
(43) Pub. Date: Feb. 24, 2022

(54) SECURE COMPUTING DEVICE

(71) Applicant: Microsoft Technology Licensing, LLC, Redmond, WA (US)

(72) Inventors: Daniel ROSENSTEIN, Issaquah, WA (US); David R. JACOBS, Woodinville, WA (US); Christopher John MCMILLAN, Woodinville, WA (US); Sven GRUENITZ, Redmond, WA (US); Daniel G. O'NEIL, Sammamish, WA (US); Mohammad TANABIAN, Bellevue, WA (US); Justin P. CAMPBELL, Woodinville, WA (US); Abhilash IYER, Bellevue, WA (US); Stefan THOM, Mill Creek, WA (US); Yong DING, Beijing (CN); Jayachandra GULLAPALLI, Sunnyvale, CA (US); Baoxi JIA, Beijing (CN); Travis Jon PERRY, Los Gatos, CA (US); Robyn E. DUNN, Seattle, WA (US); Kalpesh Sudhaker PATEL, Redmond, WA (US)

(73) Assignee: Microsoft Technology Licensing, LLC, Redmond, WA (US)

(21) Appl. No.: 17/127,406

(22) Filed: Dec. 18, 2020

Related U.S. Application Data
(60) Provisional application No. 63/068,892, filed on Aug. 21, 2020.

(51) Int. Cl. H04L 29/06; G06F 21/60; H04L 9/08; H04L 9/32; G06N 20/00

(52) U.S. Cl. CPC H04L 63/0442; G06F 21/602; H04L 2209/805; H04L 9/3271; G06N 20/00; H04L 9/0894

(57) ABSTRACT

An edge computing device includes a System-on-Module (SoM) device that communicates over USB to provide security and provides hardware artificial intelligence acceleration and hardware encryption to the edge computing device. The SoM device includes a hardware encryption module with an encryption key shared between the SoM device and the cloud server that creates an identity for the SoM device and secure authentication of the identity of the SoM device between the SoM device and a cloud server. The hardware encryption module is configured to have a secure root of trust, the ability to attest software containers distributed from the cloud server, and protect data processed on the SoM device and transmitted to the cloud server.

### CROSS REFERENCE TO RELAI ED APPLICAI IONS

This application claims priority to U.S. Provisional Patent Application No. 63/068,892, filed Aug. 21, 2020, the entirety of which is hereby incorporated herein by reference for all purposes.

### BACKGROUND

Recently, wireless connectivity and compute power have been provisioned in increasingly small computing devices, enabling these computing devices to communicate over the Internet with cloud services in a technological trend that has been referred to as the Internet of Things (IoT). Such computing devices have been referred to as edge computing devices since they are provisioned at the logical edge of a computing network, e.g., within equipment or in a facility near the end user, as opposed to at the logical center of such a system in a data center or within the intermediate networking hardware that forms the Internet and connects the data center to the edge computing device itself. One emerging technology trend is the deployment of artificial intelligence models at edge computing devices where sensors gather data and execute trained models, which are supported by artificial intelligence cloud service platforms, where the artificial intelligence models are typically developed, trained, and refined. Challenges exist to promote data security and integrity when vast amounts of sensitive data are exchanged between the edge computing devices and data centers, especially in such artificial intelligence and machine learning applications.

### SUMMARY

An edge computing device is provided, comprising a first secure cryptoprocessor and a first non-volatile memory storing a first encryption key of a secret key pair, the edge computing device being configured to communicate cryptographic messages with a remote computing device comprising a second secure processor and a second non-volatile memory storing a second encryption key of the secret key pair, according to a secure communication protocol using the first and second encryption keys; a component that is selectively disabled prior to authentication; and a processor that is configured to send an authentication request to the remote computing device according to the secure communication protocol, and in response thereto receive an authentication response from the remote computing device. The processor is configured to enable an operation of the component based on the authentication response.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a secure computing system in accordance with one example of the present disclosure.

FIG. 2 shows a schematic view of hardware encryption modules of the secure computing system of FIG. 1 in accordance with one example of the present disclosure.

FIGS. 3A and 3B show a flowchart of a method for securely exchanging data between an edge computing device and a remote computing device according to an example embodiment of the present disclosure.

FIGS. 4A to 4F show a flowchart of a method which is a secure authentication protocol to securely exchange data between an edge computing device and a remote computing device.

FIG. 5 shows a computing system according to an embodiment of the present disclosure.

FIGS. 6A and 6B show additional examples and views of a System-on-Module (SoM) device of FIG. 1 in accordance with the present disclosure.

FIG. 7 shows an additional view of a secure computing system of FIG. 1 in accordance with one example of the present disclosure.

FIG. 8 shows an additional view of a secure computing system of FIG. 1 in accordance with another example of the present disclosure.

FIG. 9 shows an additional view of a secure computing system of FIG. 1 in accordance with another example of the present disclosure.

It will be understood that the drawings are not necessarily to scale, and various dimensions and proportions may be modified.

### DETAILED DESCRIPTION

As discussed above, challenges exist to enable efficient and secure communication between edge devices implementing artificial models and artificial intelligence platforms at which such models are developed, trained, and refined. The present invention relates to securely deploying artificial intelligence models on edge computing devices for various possible machine learning applications, including visual recognition and speech recognition. Methods and systems are described for sending vast amounts of training data collected at the edge computing devices to remote computing devices to train or retrain artificial intelligence models that are subsequently securely deployed on the edge computing devices. This enables an edge computing device with sensitive proprietary data, which may be data related to a trade secret manufacturing process, for example, to gather such data with on-site sensors, and send such data as training data to the artificial intelligence platform implemented at remote computing devices in a secure manner. Using this proprietary data, the platform can train custom artificial intelligence models or refine existing artificial intelligence models, which will then be downloaded and deployed at the edge computing device, while ensuring data security and integrity. Further models that have been trained locally at the edge computing devices can be securely uploaded to the artificial intelligence platform at the remote computing devices for further analysis and training using data sets and compute resources available at the platform.

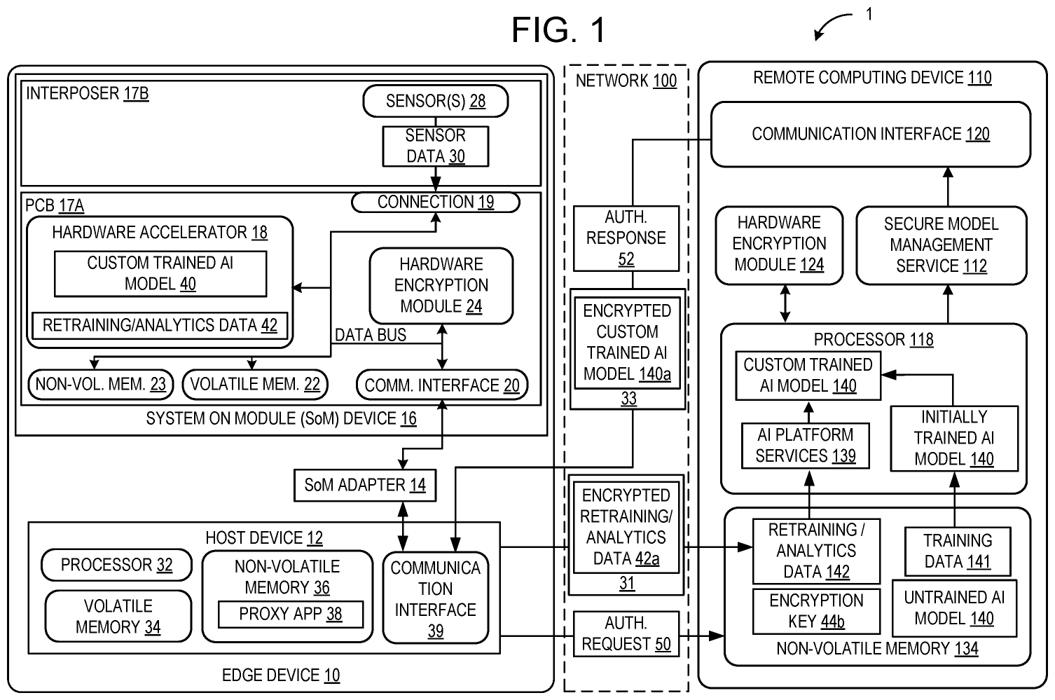

FIG. 1 illustrates a secure computing system 1 including an edge computing device 10 and a remote computing device 110 communicatively coupled to each other via a network 100. The edge computing device 10 may be embodied as an image capture device or an audio capture device, for example. The remote computing device 110, which may be configured as a cloud server, trains and deploys artificial intelligence (AI) models 140 to the edge computing device 10. The edge computing device 10 may include components that communicatively couple the device with one or more other computing devices, which may include other cloud servers besides the remote computing device 110. In some examples, the network 100 may take the form of a local area network (LAN), wide area network (WAN), wired network, wireless network, personal area network, or a combination thereof, and may include the Internet.

The edge computing device 10 comprises a system-on-module (SoM) device 16 that is coupled to a host device 12 via a communication interface 20 and a SoM adapter 14 to communicate with the host device 12 via a standard, secure communication protocol. The SoM device 16 includes a printed circuit board (PCB) 17A coupled by an electrical connection 19 to an interposer 17B. The interposer 17B may include a separate printed circuit board, or may be made of a flexible thin film construction, for example. The interposer 17B is configured to have one or more sensors 28 mounted thereto. Sensor data 30 from the sensors 28 travels along circuit paths on the interposer 17B to a connection with the printed circuit board 17A. It will be appreciated that an SoM is a board-level circuit on a printed circuit board (PCB) that integrates a system function into a single hardware module. SoMs offer the advantage of processing speed, timing, communications bus capacity and speed, etc. and can be designed for a specific system function. The SoM device 16 includes a local data bus and a power bus (not shown) to transmit data among and power the electronic components thereon.

When the SoM device 16 is plugged into the host device via the SoM adapter 14 it is physically and communicatively integrated with the host device 12 to function as one edge computing device 10. The communication interface 20 can be a USB hub, so that the SoM device 16 connects to the host device 12 via USB-C, for example. The SoM device 16 typically does not have a central processing unit (CPU) on board, as the CPU 32 of the edge computing device 10 is provided on the host device 12. The SoM device 16 and the host device 12 may be enclosed within a housing.

In the depicted embodiment, the SoM device 16 communicates with the remote computing device 110 through the host device 12. In other embodiments, the communication interface 20 provides a direct internet or intranet connection to the SoM device 16 that bypasses the host device 12. The SoM device 16 is coupled to or includes one or more sensors 28 and receives sensor data 30 from the one or more sensors 28. When the edge computing device 10 is embodied as an image capture device, the sensor 28 is one or more cameras that acquires one or more images of the use environment. When the edge computing device 10 is embodied as an audio capture device, the sensor 28 is one or more microphones that receive audio data from the use environment.

The SoM device 16 comprises a hardware accelerator 18, which is a processor that executes software instructions from a program. It is referred to as hardware because it is not a virtualized processor, but is physical component such as a vision processing unit (VPU), a neural processing unit (NPU), a graphics processing unit (GPU), a tensor processing unit (TPU), a field programmable gate array (FPGA), an application-specific integrated circuit (ASIC) for example. It is referred to as an accelerator because it is designed to process a specific type of instructions at a high rate of speed in a logical location that has a low latency connection to sensors 28 (e.g., not connected by a WAN). Typically the connection to the sensors 28 is directly by a data bus, and possibly through an expansion bus, but alternatively may be over a high speed wired or wireless connection, such as ethernet or WIFI.

One type of repetitive processing task that can be performed by the hardware accelerator 18 is processing artificial intelligence tasks, such as applying or training an artificial intelligence model. For this purpose, the hardware accelerator 18 may be a hardware AI accelerator that includes an artificial intelligence model 40 to collect sensor data 30 from the one or more sensors 28 and perform artificial intelligence or machine learning analysis on the sensor data 30, extracting features in the sensor data 30. Accordingly, hardware security and hardware accelerated artificial intelligence and machine learning can be integrated into the edge computing device 10. In the example of FIG. 1, the hardware accelerator 18 is coupled to a volatile memory 22 and non-volatile memory 23. Another type of processing task that can be performed by the hardware accelerator 18 is encoding or decoding of signals (in particular, audio and video signals) received from sensors 28 using, for example, CODECs.

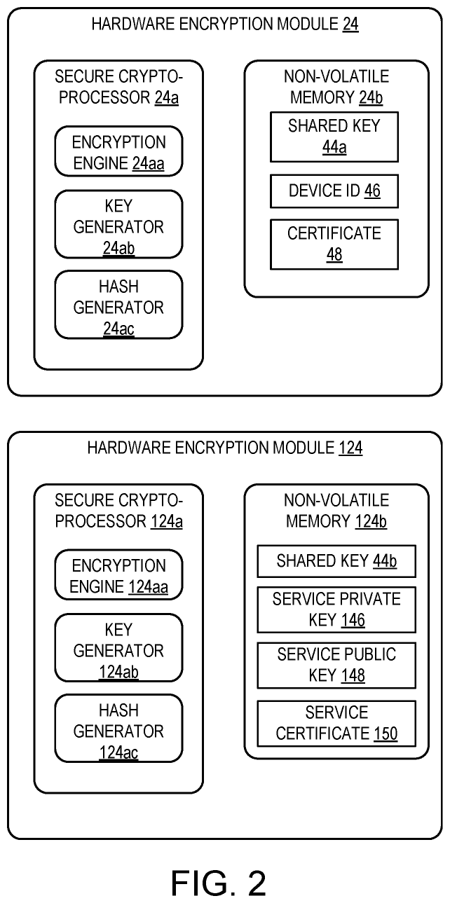

The SoM device 16 may also include a hardware encryption module 24, which may also be implemented in firmware. The hardware encryption module 24 is shown in detail in FIG. 2. In the example of FIG. 2, the hardware encryption module 24 is embodied as a secure cryptoprocessor 24a and non-volatile memory 24b as the security component of the edge computing device 10 embedded on the SoM device 16. The non-volatile memory 24b of the hardware encryption module 24 stores a shared secret key 44a to use for hardware encryption. The secure cryptoprocessor 24a may have an encryption engine 24aa to encrypt data, a key generator 24ab to generate encryption keys, and a hash generator 24ac to generate hashes.

The secure cryptoprocessor 24a is designed to have a secure root of trust, have the ability to check and validate software components or containers distributed from the cloud server 110, and protect data that is transmitted to the cloud server 110 from the edge computing device 10. The validation of software components or containers is also known as attestation. Accordingly, when the artificial intelligence model received from the cloud server 110 is trusted and verified, the security component 24 of the edge computing device 10 enables the hardware accelerator 18.

A shared secret encryption key (first encryption key) 44a is a unique hardware encryption key which is created and stored within a non-volatile memory 24b of the hardware encryption module 24 during manufacturing production of the SoM device 16. The shared secret key 44a is not revealed to any hardware or software external to the SoM device 16, except to the cloud server 110. The shared secret key 44a may be an endorsement key or a storage root key, for example. A unique device identification (ID) 46 and a security certificate 48 may also be stored in the non-volatile memory 24b of the hardware encryption module 24. At the time of manufacturing the SoM device 16, the device ID 46, certificate 48, and shared secret key 44a are shared between the manufacturing facility and the cloud server 110, so that when the SoM device 16 is powered on, the SoM device 16 shares back the device ID 46 and certificate 48 information that the cloud server 110 already has. Accordingly, the shared secret key 44a does not have to be transmitted between the edge computing device 10 and the remote computing device 110 when exchanging sensitive data.

Referring back to FIG. 1, the host device 12, which is operatively coupled to the SoM device 16, stores in volatile memory 34 a proxy application 38 which is retrieved from non-volatile memory 36 to be executed by the processor 32 to authenticate data outflows and data inflows between the edge computing device 10 and the remote computing device 110. Communication between the edge computing device 10 and the cloud server 110 is performed over a communication interface 39, which may be a network adapter, such as, in one specific example, a USB-ethernet/Wi-Fi adapter. Other network adapters are also possible.

When the SoM device 16 does not have a direct network connection to the cloud server 110, the authentication of the SoM device 16 is performed by a cloud service of the cloud server 110 through the proxy application 38 on the host device 12 which has a direct network connection to the cloud server 110.

In one example, the sensor data 30 is packaged as retraining data 42 in a first data package 31 by the hardware accelerator 18 to train the untrained artificial intelligence model 140 of the cloud server 110. The retraining and analytics data 42 is encrypted by the secure cryptoprocessor 24a using the shared secret key 44a, so that sensitive data is transmitted via a cryptographic message derived out of the unique hardware encryption key 44a. Before the encrypted retraining data 42a is transmitted to the cloud server 110, an authentication protocol is performed sending an authentication request 50 including the unique device ID 46 and/or certificate 48 of the SoM device 16 to the cloud server 110 to identify the SoM device 16 as the source of the retraining data 42. Accordingly, a unique identity is created for the SoM device 16 for identification by the cloud server 110. In this example, a processor 32 of the edge computing device 10, embedded on the host device 12, is configured to send the authentication request 50 to the remote computing device 110 according to the authentication protocol which is a secure communication protocol.

The encrypted retraining data and analytics 42a is transmitted to the cloud server 110 via a communication interface 39 of the host device 12 or the communication interface 20 of the SoM device 16. The retraining and analytics data 42 includes sensor data 30 and may also include label data such as ground truth inputs by human operators that is paired with the sensor data as labeled training data pairs. In some cases, the AI model 140 may be trained at the edge computing device 10 based on edge-procured sensor data 30, and the further trained model 140 itself may be uploaded to the remote computing device 110 within retraining and analytics data 142. Further analytics data regarding performance of the custom trained AI model 40 itself at the edge computing device 10 may be transmitted from the host device 12 to the remote computing device 110. The retraining data 142 is stored in non-volatile memory 134 of the cloud server 110. The non-volatile memory 134 also stores an untrained artificial intelligence model 140 and the shared secret key 44b to decrypt the encrypted retraining data 42a. It will be appreciated that the untrained AI model 140 is typically trained on training data 141 by training algorithms implemented by AI platform services 139 at the processor 118, and then may be further trained to generate a custom trained AI model 140 based on the retraining data contained within the retraining and analytics data 142 received from the edge computing device 10.

Processor 118 is typically a CPU, but can alternatively be a hardware accelerator. The processor 118 may be a FPGA, GPU, a TPU, a VPU, an NPU, an ASIC, or other suitable hardware accelerator device, for example.

Following retraining, the custom trained artificial intelligence model 140 is encrypted by a hardware encryption module 124 using the shared secret key 44b to produce an encrypted custom trained artificial intelligence model 140a. Alternatively, the encryption may be performed by processor 118 itself, rather than by a dedicated hardware encryption module 124 at the remote computing device 110. A secure management service 112 executed on the remote computing device 110 packages the encrypted custom trained artificial intelligence model 140a into a container (second data package) 33, which is transmitted via the communication interface 120 of the remote computing device 110 to the edge computing device 10. Subsequent to performing the authentication protocol, including receiving the authentication request 50 and performing validation and key agreement, a validation result is encrypted and concatenated into an authentication response 52, and the communication interface 120 of the remote computing device 110 transmits the authentication response 52 to the edge computing device 10.

The communication interface 39 of the edge computing device 10 receives the second data package 33 from the remote computing device 110, then the secure cryptoprocessor 24a authenticates the second data package 33 and decrypts the second data package 33, which may include an encrypted AI model 140a trained on the training or retraining data 141 and transmitted by the communication interface 120. The processor 32 of the edge computing device 10 is configured to enable an operation of the hardware accelerator 18 of the SoM device 16 of the edge computing device 10 based on the authentication response 52, the hardware accelerator 18 being selectively disabled prior to authentication. However, when no authentication response 52 is received from the remote computing device 110, the processor 32 prohibits the operation of the hardware accelerator 18, and leaves the hardware accelerator 18 disabled. The decrypted second data package 33 is subsequently stored and executed on the hardware accelerator 18. It will be appreciated that a component of the edge computing device 10 other than the hardware accelerator 18 may alternatively or additionally be enabled based on the authentication response 52. Thus, a component that is selectively disabled prior to authentication may be enabled by the processor 32, which is configured to send an authentication request 50 to the remote computing device 110 according to the secure communication protocol, and in response thereto receive an authentication response 52 from the remote computing device 110, and enable an operation of the component based on the authentication response 52.

Referring to FIG. 2, like the hardware encryption module 24 of the edge computing device 10, the hardware encryption module 124 may be embodied as a secure cryptoprocessor 124a and non-volatile memory 124b as the security component of the remote computing device 110. The non-volatile memory 124b of the hardware encryption module 124 stores the shared secret key (second encryption key) 44b to use for hardware encryption, a service private key 146, a service public key 148, and a service certificate 150. The shared secret key 44a at the SoM device 16 and the shared secret key 44b at the remote computing device 110 comprise a secret key pair which match upon performing a key agreement. The secure cryptoprocessor 124a may have an encryption engine 124aa to encrypt data, a key generator 124ab to generate encryption keys, and a hash generator 124ac to generate hashes.

Referring back to FIG. 1, the SoM device 16 authenticates the received encrypted trained artificial intelligence model 140a as genuine via the secure cryptoprocessor 24a, and the encrypted trained artificial intelligence model 140a is decrypted by the secure cryptoprocessor 24a to generate the trained artificial intelligence model 40, which is deployed at the hardware accelerator 18 to process sensor data 30 from the one or more sensors 28. Alternatively, the received encrypted trained artificial intelligence model 140a is verified as genuine via the proxy application 38 on the host device 12 which has a secure network connection with the cloud server 110.

The edge computing device 10 exchanges secure data with the remote computing device 110 after receiving the authentication response 52 from the remote computing device 110. The secure data is encrypted by the edge computing device 10 using the first encryption key 44a and decrypted by the remote computing device 110 using the second encryption key 44b, and/or encrypted by the remote computing device 110 using the second encryption key 44b and decrypted by the edge computing device 10 using the first encryption key 44a. The secure data may include artificial intelligence (AI) model data, AI model training or retraining data, and/or AI model analytics data.

The secure cryptoprocessor 24a of the SoM device 16 implements an authentication protocol to receive the authentication response 52 from the remote computing device 110, decrypt the encrypted validation result in the authentication response 52 using the secret key 44a, and control the hardware accelerator 18 on the SoM device 16 to enable the hardware accelerator 18. The secure cryptoprocessor 124a of the remote computing device 110 may likewise implement the same authentication protocol to control the artificial intelligence accelerator 118 on the remote computing device 110. This authentication protocol may be based on DICE (Device Identifier Composition Engine) implementing certificate chain verification, for example. It will be appreciated that the authentication protocol does not require the edge computing device 10 and the remote computing device 110 to send each other secret encryption keys when exchanging sensitive data. Accordingly, the risk of a man-in-the-middle attack intercepting and decrypting sensitive data is greatly reduced when exchanging sensitive data between the edge computing device 10 and the remote computing device 110.

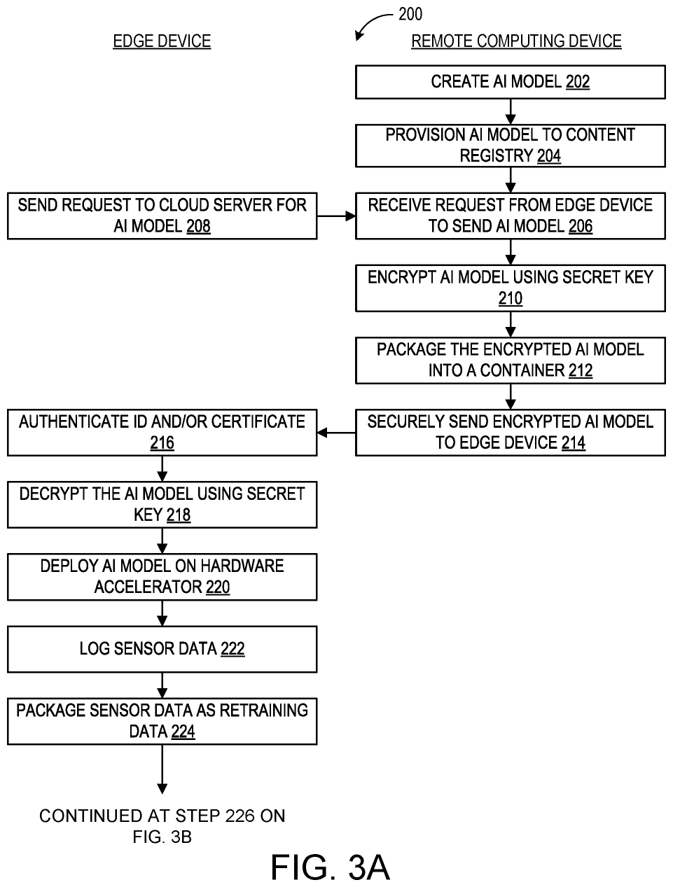

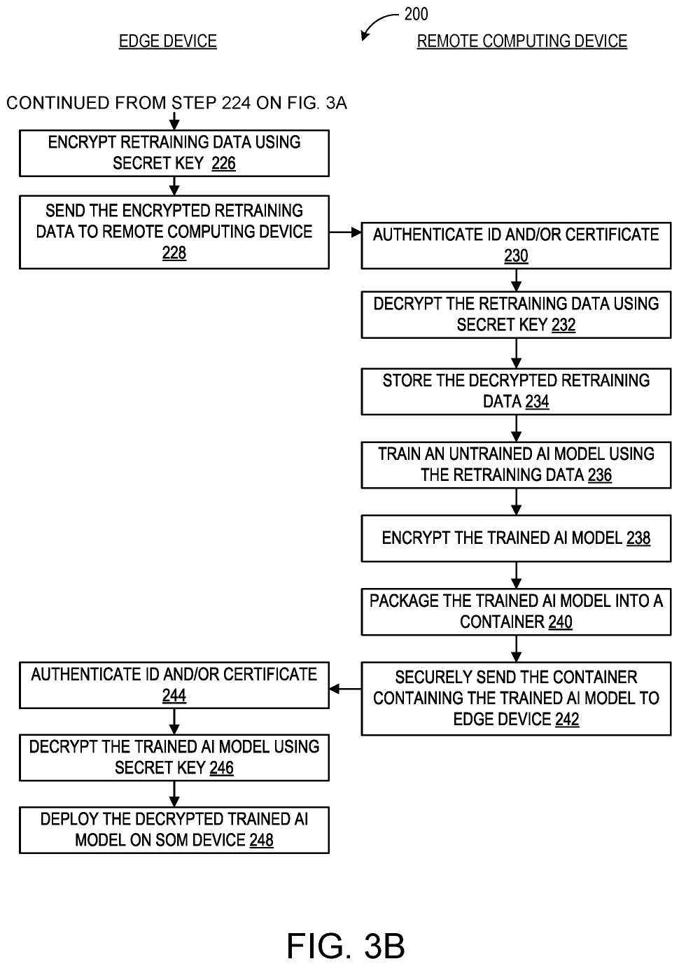

FIGS. 3A and 3B illustrate a flowchart of a method 200 for securing data that is exchanged between an edge computing device and a remote computing device. The following description of method 200 is provided with reference to the software and hardware components described above and shown in FIGS. 1 and 2. It will be appreciated that method 200 also may be performed in other contexts using other suitable hardware and software components.

At step 202, at the remote computing device, an artificial intelligence model is created. At step 204, at the remote computing device, the artificial intelligence model is provisioned to a content registry. At step 208, at the edge computing device, a request for the artificial intelligence model is sent to the remote computing device. This request for the artificial intelligence model at the edge computing device may be initiated by the remote computing device. At step 206, the request from the edge computing device is received by the remote computing device. At step 210, the artificial intelligence model is encrypted by the remote computing device using the shared secret key. At step 212, the encrypted artificial intelligence model is packaged into a container by a secure model management service of the remote computing device. At step 214, the container containing the encrypted artificial intelligence model is securely sent by the remote computing device to the edge computing device.

At step 216, the device ID and/or certificate is authenticated by the secure cryptoprocessor of the edge computing device upon receiving the encrypted artificial intelligence model. At step 218, the encrypted artificial intelligence model is decrypted by the secure cryptoprocessor of the edge computing device using the shared secret key. At step 220, the decrypted artificial intelligence model is deployed on the hardware accelerator on the SoM device.

At step 222, the hardware accelerator on the SoM device logs sensor data that is processed by the artificial intelligence model executed on the hardware accelerator. At step 224, the SoM device packages the logged sensor data as retraining data.

At step 226, the retraining data is encrypted by the edge computing device using the shared secret key. At step 228, the encrypted retraining data is sent to the remote computing device. At step 230, the device ID and/or certificate is authenticated by a secure cryptoprocessor of the remote computing device upon receiving the encrypted retraining data. At step 232, the encrypted retraining data is decrypted by the secure cryptoprocessor of the remote computing device using the shared secret key. At step 234, the decrypted retraining data is stored in non-volatile memory of the remote computing device. At step 236, the untrained artificial intelligence model is trained by the remote computing device using the retraining data to produce a trained artificial intelligence model. At step 238, the trained artificial intelligence model is encrypted by the secure cryptoprocessor of the remote computing device. At step 240, the encrypted trained artificial intelligence model is packaged into a container by the secure model management service of the remote computing device. At step 242, the container containing the encrypted trained artificial intelligence model is securely sent by the remote computing device to the edge computing device.

At step 244, the device ID and/or certificate is authenticated by the secure cryptoprocessor of the edge computing device upon receiving the encrypted artificial intelligence model. At step 246, the encrypted trained artificial intelligence model is decrypted by the secure cryptoprocessor of the edge computing device using the shared secret key. At step 248, the decrypted trained artificial intelligence model is deployed on the hardware accelerator on the SoM device.

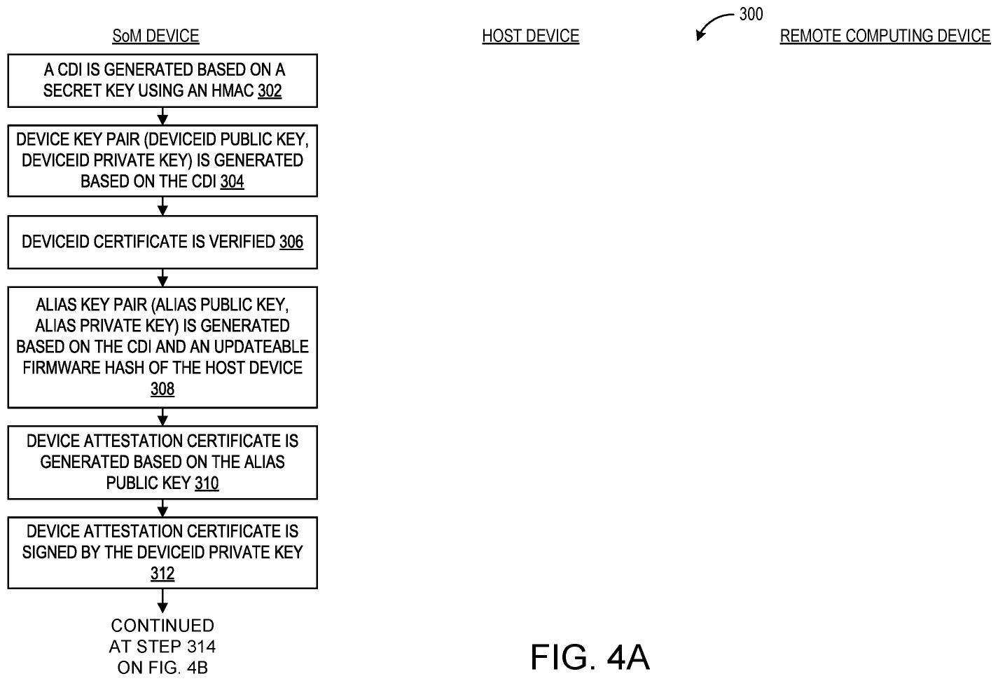

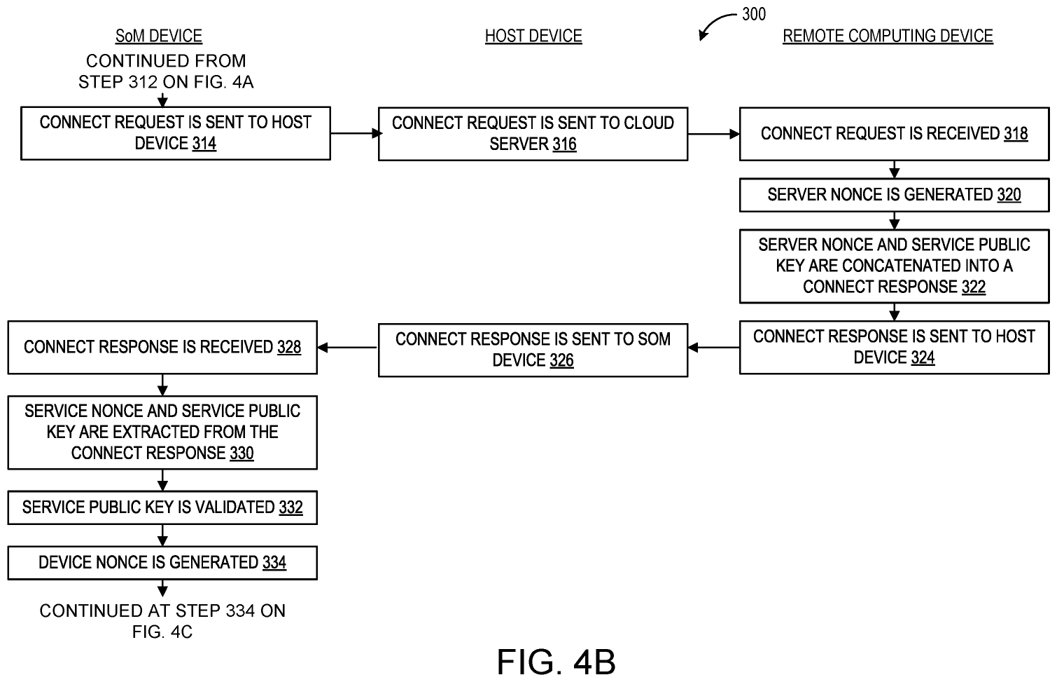

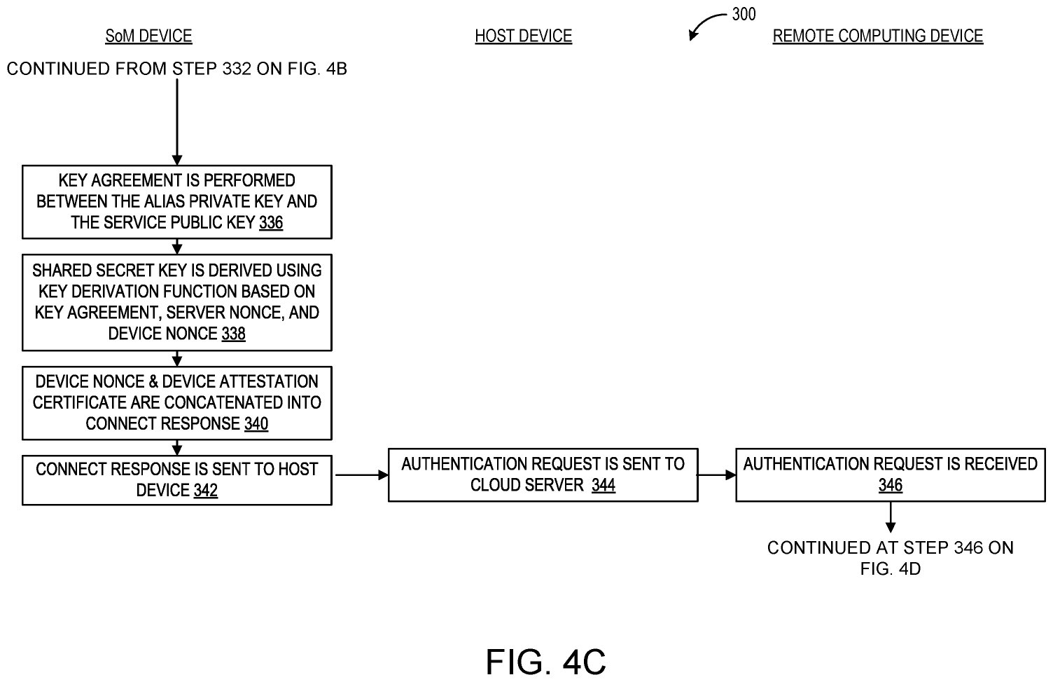

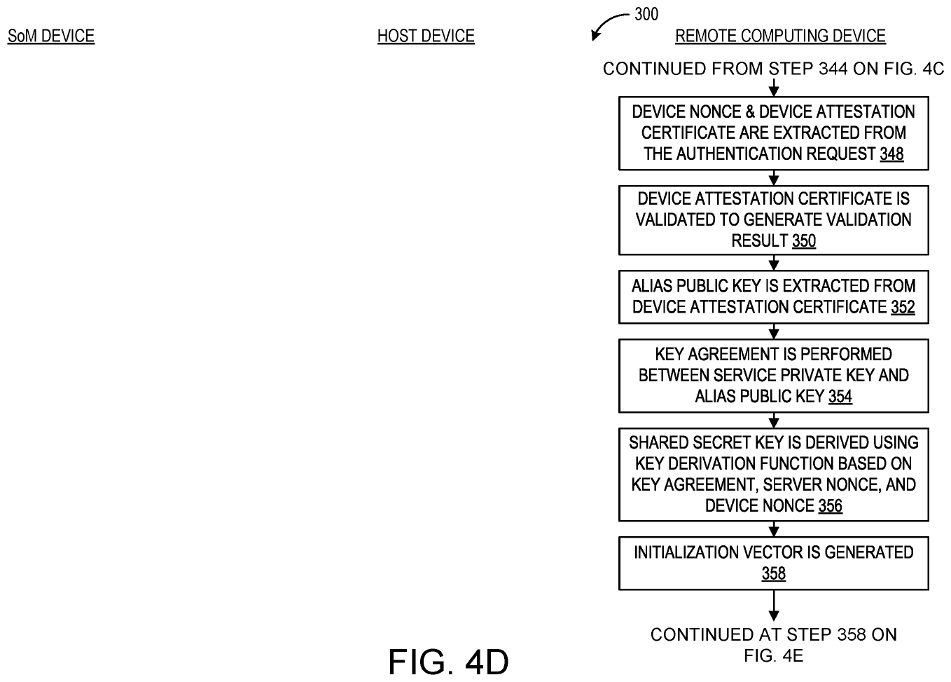

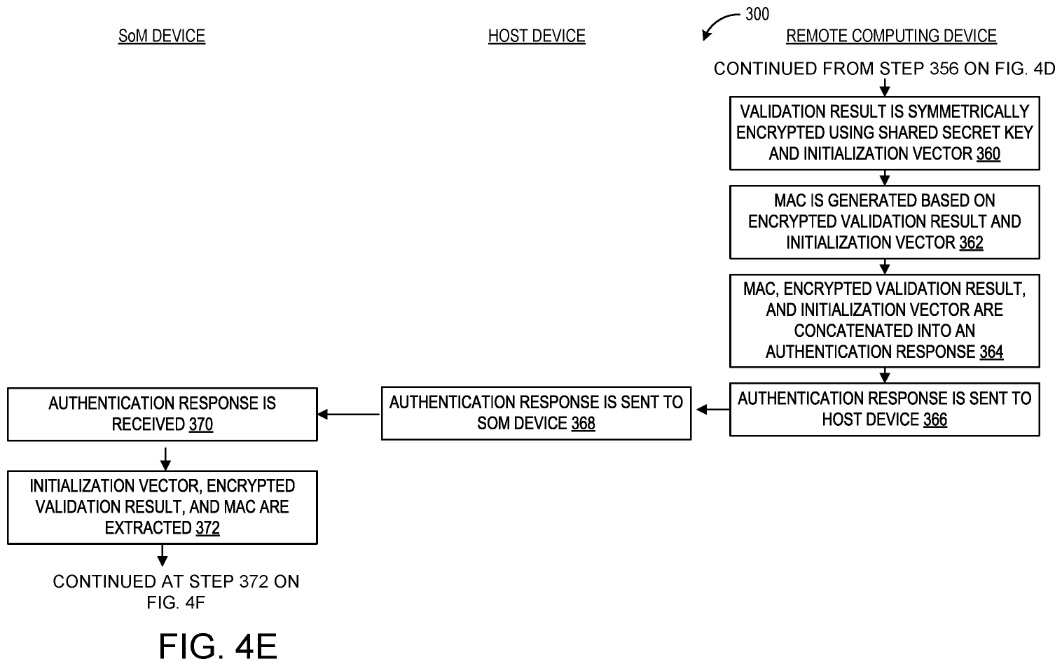

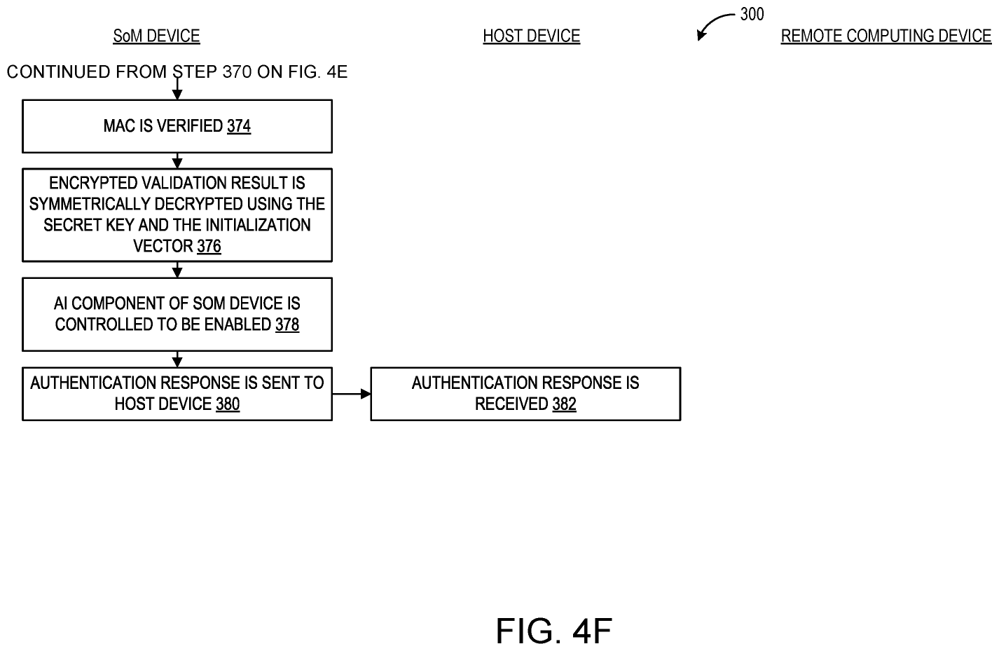

FIGS. 4A to 4F illustrate a flowchart of a method 300 which is a secure authentication protocol to securely exchange data between an edge computing device and a remote computing device, especially in a situation in which the SoM device cannot access the network directly, but accesses the network through the host device to which the SoM device is connected. On the SoM device, a secure processor may use DICE as the root of trust and implement the method 300 to control the hardware accelerator of the SoM device. The following description of method 300 is provided with reference to the software and hardware components described above and shown in FIGS. 1 and 2. It will be appreciated that method 300 also may be performed in other contexts using other suitable hardware and software components.

To bootstrap a secure channel, the edge computing device and the cloud server exchange public keys, perform key agreement, and derive a shared secret key for encryption and decryption. The validator application executed by the host device behaves as a proxy between the edge computing device and the cloud server to transmit the data transparently.

At step 302, at the SoM device, a CDI (Compound Device Identity) is generated based on UDS (Unique Device Secret) using an HMAC (hash-based message authentication code). The CDI is a secret value that is unique to the SoM device and the cryptographic identity (e.g. the hash) of the DICE Core layer that the SoM device booted. The UDS is a statistically unique, device-specific, secret value. The UDS may be generated externally and installed during manufacture or generated internally during device provisioning. The UDS is to be stored in non-volatile memory on the SoM device to which the DICE can restrict access.

At step 304, at the SoM device, an ECDSA (elliptic curve digital signature algorithm) device key pair is generated based on the CDI. The key pair includes a DevicelD (Device Identity) public key (deviceid_pub), and a DevicelD private key (deviceid_priv). The DevicelD key pair is an asymmetric key pair that serves as a long-term identifier for the SoM device. At step 306, at the SoM device, the DevicelD certificate (deviceid_cert) is retrieved from the SoM device and verified as signed by the manufacture CA private key. The DevicelD certificate is generated and provisioned to the SoM device in the manufacturing process.

At step 308, at the SoM device, an ECDSA alias key pair is generated based on the CDI and an updateable firmware hash of the host device. The alias key pair comprises a public alias key (alias_pub) and a private alias key (alias_priv). Alias keys are asymmetric key pairs created by a device; new alias keys are created for each new firmware revision.

At step 310, at the SoM device, an ECDSA device attestation certificate (alias_cert) is generated based on the alias public key. At step 312, at the SoM device, the device attestation certificate is signed by the DevicelD private key.

At step 314, at the SoM device, a connect request is sent to the validator application on the host device. At step 316, at the host device, the connect request is received and sent to the cloud server.

At step 318, at the cloud server, the connect request from the SoM device is received. The cloud server possesses a service certificate, a service public key, and a service private key. At step 320, at the cloud server, a server nonce is generated. At step 322, at the cloud server, the server nonce and a service public key (service_pub) are concatenated into a connect response. At step 324, at the cloud server, the connect response including the concatenated service public key and server nonce is sent to the validator application on the host device.

At step 326, at the host device, the connect response is received and sent to the SoM device. At step 328, at the SoM device, the connect response is received. At step 330, at the SoM device, the service nonce and service public key are extracted from the connect response. At step 332, at the SoM device, the service public key is validated to make sure that the service public key originated from the cloud server. At step 334, at the SoM device, a device nonce is generated.

At step 336, at the SoM device, a key agreement is performed between the alias private key and the service public key. At step 338, at the SoM device, a shared secret key is derived using a key derivation function (KDF) based on the key agreement, the server nonce, and the device nonce. At step 340, at the SoM device, the device nonce and the device attestation certificate are concatenated into a connect response.

At step 342, at the SoM device, a connect response is sent to the validator application on the host device, the connect response containing the concatenated device nonce and the device attestation certificate. At step 344, at the host device, the authentication request is received and sent to the cloud server.

At step 346, at the cloud server, the authentication request is received. At step 348, at the cloud server, the device nonce and the device attestation certificate are extracted from the authentication request. At step 350, at the cloud server, the device attestation certificate is validated to generate a validation result.

At step 352, at the cloud server, the alias public key is extracted from the device attestation certificate. At step 354, at the cloud server, a key agreement is performed between a service private key and the alias public key. At step 356, at the cloud server, a shared secret key is derived using a key derivation function based on the key agreement, the server nonce, and the device nonce. At step 358, at the cloud server, an initialization vector is generated.

At step 360, at the cloud server, the validation result is symmetrically encrypted using the shared secret key and the initialization vector. At step 362, at the cloud server, a MAC (message authentication code) is generated based on the encrypted validation result and the initialization vector. At step 364, at the cloud server, the MAC, the encrypted validation result, and the initialization vector are concatenated into an authentication response.

At step 366, at the cloud server, the authentication response containing the concatenated MAC, encrypted validation result, and initialization vector is sent to the validator application on the host device. At step 368, at the host device, the authentication response is received and sent to the SoM device.

At step 370, at the SoM device, the authentication response is received. At step 372, at the SoM device, the initialization vector, the encrypted validation result, and the MAC are extracted. At step 374, at the SoM device, the MAC is verified. At step 376, at the SoM device, the encrypted validation result is symmetrically decrypted using the secret key and the initialization vector.

At step 378, at the SoM device, the AI component of the SoM device is controlled to be enabled based on the decrypted validation result. At step 380, at the SoM device, an authentication response is sent to the validator application on the host device. At step 382, at the SoM device, the authentication response is received by the host device.

Accordingly, the artificial intelligence model is secured from the time of creation to packaging at the cloud server to deployment and execution on the edge computing device. The data security extends to the memory and storage on the devices, securing the artificial intelligence model that is acquired by the edge computing device, and securing the retraining data which is transmitted to the cloud server for retraining the artificial intelligence model. The hardware-based security provided to the edge computing device and the cloud server is coupled with hardware accelerated artificial intelligence. Each hardware encryption module has a secure unique ID, certificate, and encryption key, as well as the capability to perform hardware-based encryption through the secure hardware encryption module. The hardware requirements allow for compact, simple integration of data security into a small form factor. As attestation is performed between the edge computing device and the cloud server, the integrity of the edge computing device and the integrity of the cloud server are maintained, ensuring that the execution environment of the two devices remains secure. Encryption and decryption of the retraining data and the artificial intelligence models are performed within this secure execution environment in a secure, complete end-to-end protected system, thereby reducing the risk of security breaches.

In some embodiments, the methods and processes described herein may be tied to a computing system of one or more computing devices. In particular, such methods and processes may be implemented as a computer-application program or service, an application-programming interface (API), a library, and/or other computer-program product.

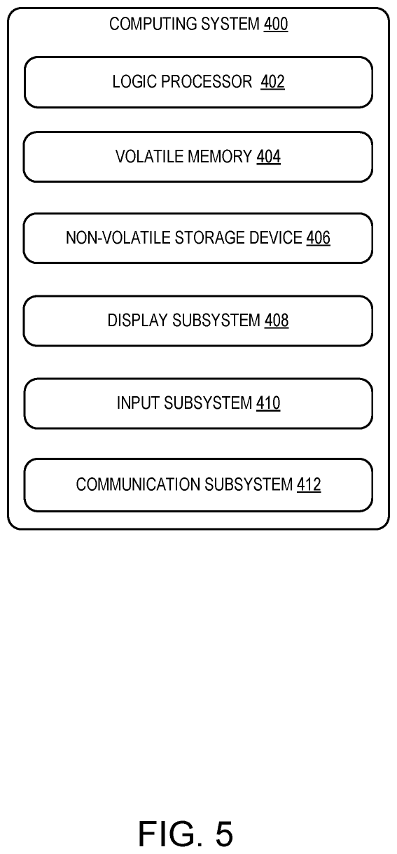

FIG. 5 schematically shows a non-limiting embodiment of a computing system 400 that can enact one or more of the methods and processes described above. Computing system 400 is shown in simplified form. Computing system 400 may embody the edge computing device 10 or remote computing device 110 of FIGS. 1 and 2. Computing system 400 may take the form of one or more personal computers, server computers, tablet computers, home-entertainment computers, network computing devices, gaming devices, mobile computing devices, mobile communication devices (e.g., smartphone), and/or other computing devices, and wearable computing devices such as smart wristwatches and head mounted augmented reality devices.

Computing system 400 includes a logic processor 402 volatile memory 404, and a non-volatile storage device 406. Computing system 400 may optionally include a display subsystem 408, input subsystem 410, communication subsystem 412, and/or other components not shown in FIGS. 1 and 2.

Logic processor 402 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 402 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 406 includes one or more physical devices configured to hold instructions executable by the logic processors to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by logic processor 402 to temporarily store information during processing of software instructions. It will be appreciated that volatile memory 404 typically does not continue to store instructions when power is cut to the volatile memory 404.

Aspects of logic processor 402, volatile memory 404, and non-volatile storage device 406 may be integrated together into one or more hardware-logic components. Such hardware-logic components may include field-programmable gate arrays (FP GAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via logic processor 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with logic processor 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wireless telephone network, or a wired or wireless local- or wide-area network, such as Bluetooth and HDMI over Wi-Fi connection. In some embodiments, the communication subsystem may allow computing system 400 to send and/or receive messages to and/or from other devices via a network such as the Internet.

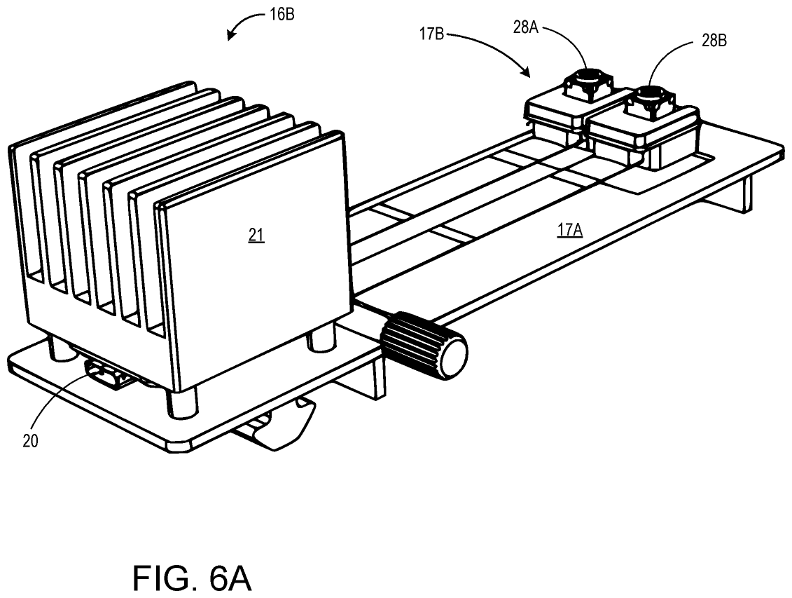

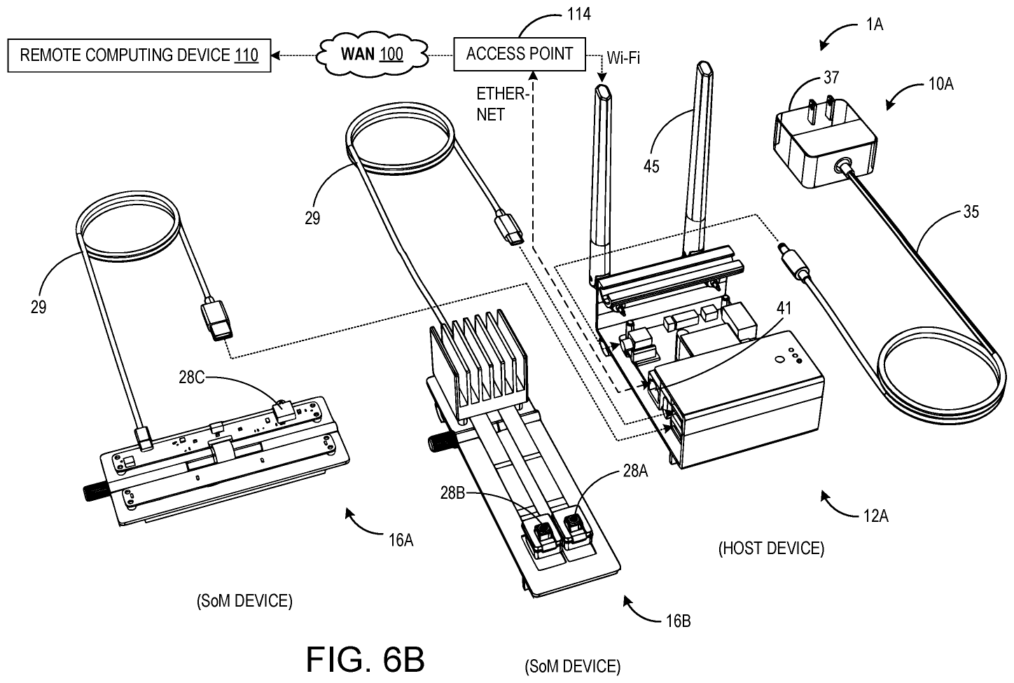

FIGS. 6A and 6B show additional views and examples of the SoM device 16 of FIG. 1 in accordance with an example of the present disclosure. FIG. 6A shows a SoM device 16 embodied as a vision module 16B that includes a plurality of (two in this embodiment) cameras 28A, 28B mounted to respective interposers 17B, which in turn are connected to a PCB 17A mounted under a heat sink 21, with a USB-C communication interface 20 for connectivity. Configured in this way, the vision module 16B is configured to perform visual recognition on image data from the cameras 28A, 28B.

FIG. 6B illustrates a secure computing system 1A including an edge computing device 10A and a remote computing device 110 communicatively coupled to each other via a network 100. FIG. 6B shows vision module 16B and additionally shows a SoM device 16 embodied as a voice module 16A that includes a microphone 28C and is equipped to perform speech recognition on audio data from the microphone 28C. FIG. 6B also shows a host device 12 configured as a compute module 12A. Compute module 12A is configured to connect to the vision module 16B and the voice module 16A by USB cables 29, and to a power adapter 37 via a power cable 35, as shown. An ethernet port 41 as well as Wi-Fi radio 45 is provided on the compute module 12A for two channels of potential connectivity with an access point 114 to the network 100 and the internet. In this way, the compute module 12A can communicate with the remote computing device 110. It will be appreciated that the compute module 12A may also be connected wirelessly or in a wired manner to other remote sensors. Further, in some embodiments, the compute module 12A may be provided with a hardware accelerator and hardware encryption module as described above to securely perform artificial intelligence tasks on data collected from the remote sensors.

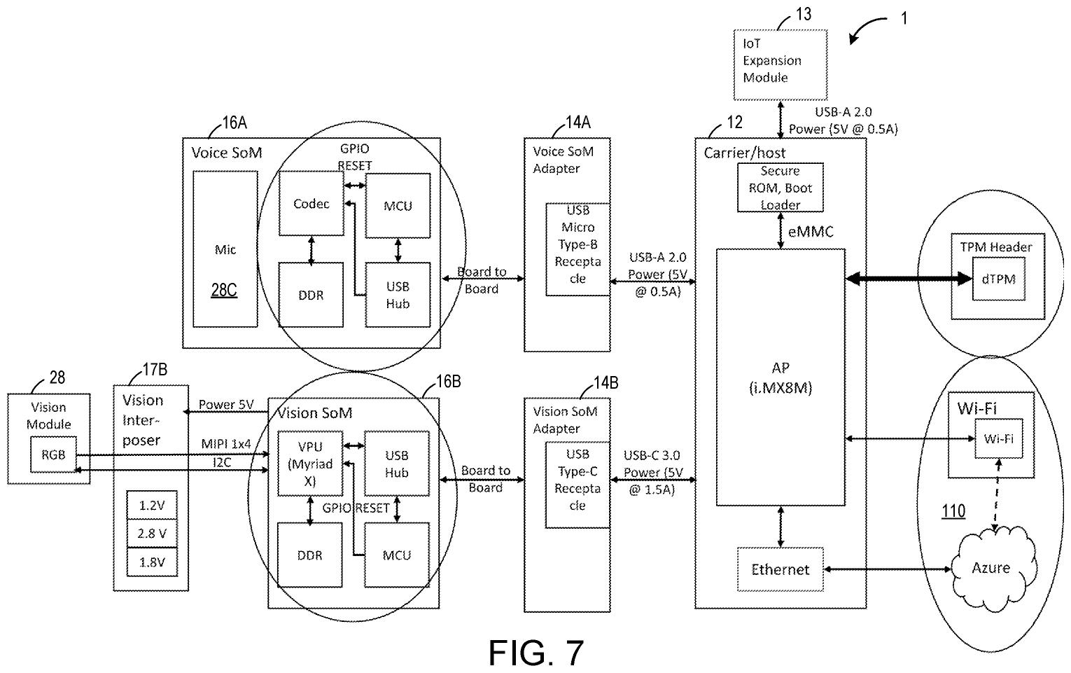

FIG. 7 is an additional view of the secure computing system 1 of FIG. 1 in accordance with an example of the present disclosure. FIG. 7 shows a visual SoM device, such as the vision module 16B of FIG. 6, and a voice SoM device, such as the voice module 16A of FIG. 6, coupled to one host device 12, such as the compute module 12A of FIG. 6, which is in turn connected to a cloud service, which may be executed on the remote computing device 110 of FIGS. 1 and 6, for example. It will be appreciated that the visual SoM device 16B and the voice SoM device 16A are not directly connected to the network, but are communicatively coupled to the cloud server 110 via the network connection of the host device 12. It will be appreciated that the host device 12 may be coupled to other adapters and modules, including an IoT expansion module 13.

In this example, the voice SoM device 16A is communicatively coupled to the host device 12 via a voice SoM adapter 14A. The voice SoM device 16A is connected to the voice SoM adapter 14A via a board-to-board connection, and the voice SoM adapter 14A is connected to the host device 12 via a USB connection. The vision SoM device 16B is communicatively coupled to the host device 12 via a vision SoM adapter 14B. The vision SoM device 16B is connected to the vision SoM adapter 14B via a board-to-board connection, and the vision SoM adapter 14B is connected to the host device 12 via a USB connection. Optical sensors 28 are coupled to the vision SoM device 16B via a vision interposer 17B. On the other hand, the microphone 28C is embedded on the voice SoM device 16A without an interposer coupling the microphone 28C and the voice SoM device 16A.

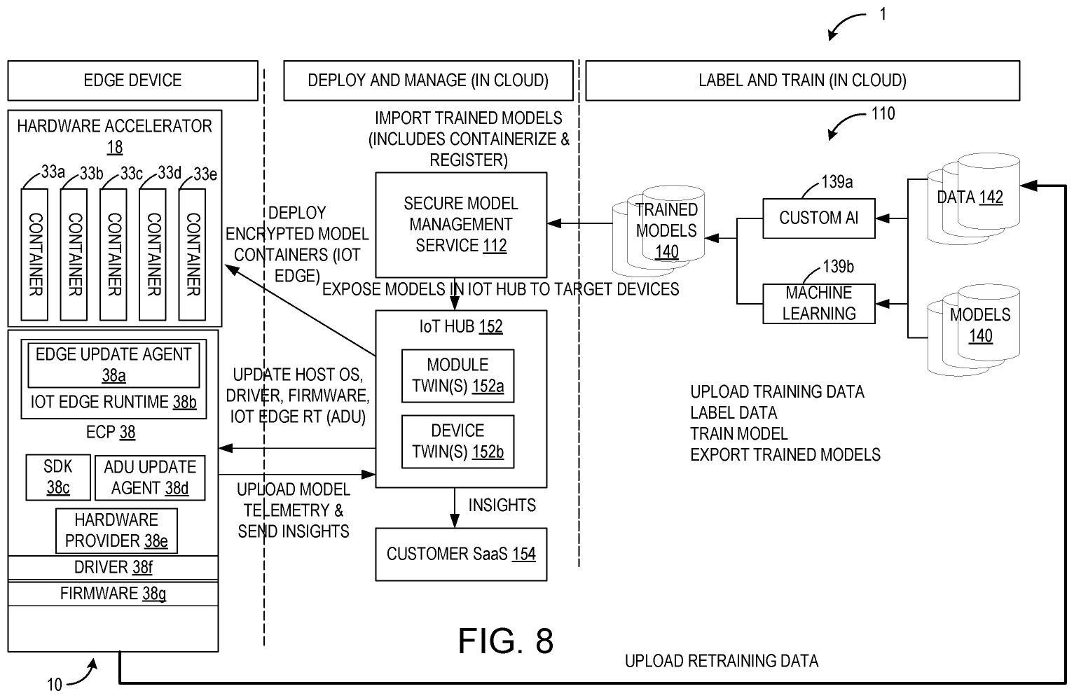

FIG. 8 is an additional view of the secure computing system 1 of FIG. 1 in accordance with another example of the present disclosure. In the example of FIG. 8, the edge computing device 10 not only uploads retraining data to the cloud server, but also uploads model telemetry and insights. The cloud server 110 not only deploys encrypted AI model containers 33 to the edge computing device 10, but also sends operating system and firmware updates 38a-g for the host device 10 that is connected to the SoM device.

Training data 142 is uploaded to the remote computing device 110. The training data 142 is labeled, the AI models 140 are trained via AI platform services, including custom AI 139a and machine learning 139b services, and the trained AI models 140 are exported to a secure model management service 112 within the remote computing device 110. The secure model management service 112 imports the trained AI models 140 and exposes the trained AI models in an IoT hub 152 to target devices: a module twin 152a and a device twin 152b. The IoT hub 152 deploys the encrypted AI models 140 in containers 33a-e to the hardware accelerator 18 of the edge device. The IoT hub 152 also updates the host application 38 including the IoT edge runtime application 38b, the edge update agent 38a, software development kit 38c, an appliance diagnostic utility (ADU) update agent 38d, hardware provider 38e, drivers 38f, and firmware 38g. The edge device may upload model telemetry and insights to the IoT hub 152, which may send the insights to a customer SaaS (software-as-a-service) 154 on the remote computing device 110. The edge device uploads retraining data 142 to the remote computing device 110 to repeat the process of training the AI models 140.

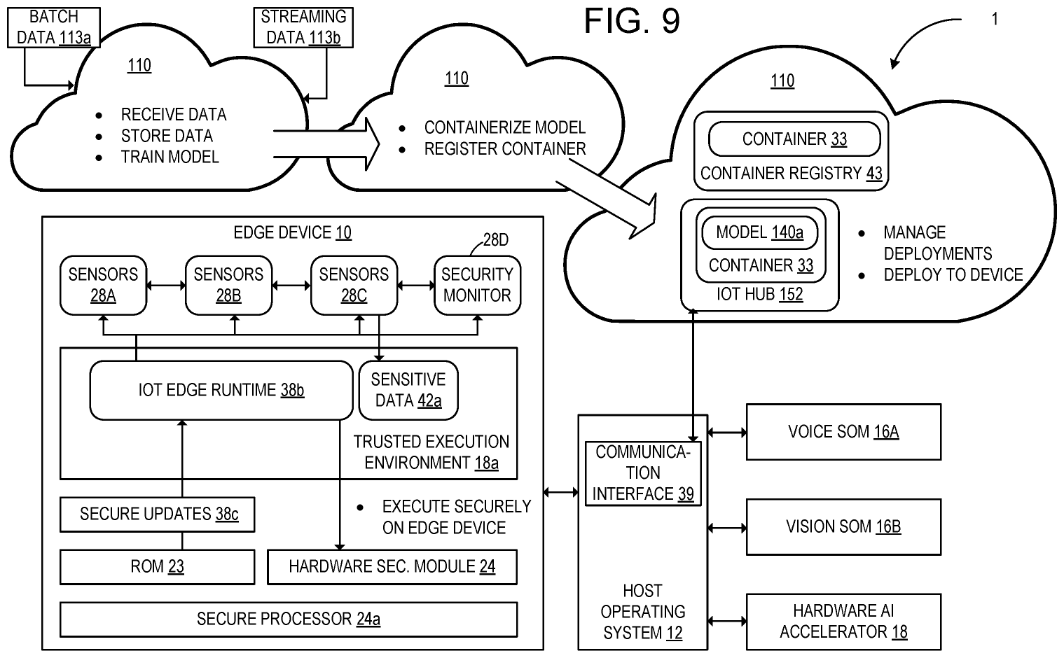

FIG. 9 is an additional view of the secure computing system 1 of FIG. 1 in accordance with another example of the present disclosure. In the example of FIG. 9, an AI model 140a that is trained, registered, packaged into a container 33 at the cloud server 110 and subsequently deployed in a trusted execution environment 18a of the edge device 10 is depicted. An IoT edge run-time application 38b is executed in the trusted execution environment 18a, receiving secure updates 38c from the non-volatile memory 23 of the edge device 10 and securely exchanging data with the hardware security module 24. The IoT edge run-time application 38b may also receive sensitive data 42a from sensor modules 28A-C and security monitor 28D that are coupled to the IoT edge run-time application 38b.

In this example, the cloud server 110 receives data including batch data 113a and streaming data 113b. The cloud server 110 subsequently stores the data, trains an AI model 140a, containerizes the AI model 140a into a container 33, and registers the container 33 at a container registry 43. The IoT hub 152 of the cloud server 110 manages the deployment of the AI model 140a to the edge device 10, and manages the deployment of other containers to the edge device 10 and other edge devices, including a voice SoM device 16A, a vision SoM device 16B, and a hardware AI accelerator 18. The IoT hub 152 communicates with the communication interface 39 of the host operating system 12 to securely send the containerized AI model 140a to the edge device 10. At the edge device 10, the secure processor 24a authenticates container 33, decrypts the encrypted AI model 140a, and deploys the decrypted AI model 140a in the trusted execution environment 18a.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The following paragraphs provide additional support for the claims of the subject application. An edge computing device comprises a first secure cryptoprocessor and a first non-volatile memory storing a first encryption key of a secret key pair, the edge computing device being configured to communicate cryptographic messages with a remote computing device comprising a second secure processor and a second non-volatile memory storing a second encryption key of the secret key pair, according to a secure communication protocol using the first and second encryption keys; a component that is selectively disabled prior to authentication; and a processor that is configured to send an authentication request to the remote computing device according to the secure communication protocol, and in response thereto receive an authentication response from the remote computing device, the processor being configured to enable an operation of the component based on the authentication response. In this aspect, the edge computing device may exchange secure data with the remote computing device after receiving the authentication response from the remote computing device. In this aspect, the secure data may include artificial intelligence (AI) model data, AI model training or retraining data, and/or AI model analytics data. In this aspect, the secure data may be encrypted by the edge computing device using the first encryption key and decrypted by the remote computing device using the second encryption key, and/or encrypted by the remote computing device using the second encryption key and decrypted by the edge computing device using the first encryption key. In this aspect, the edge computing device may further comprise a System-on-Module (SoM) device comprising one or more sensors; a communication interface; a hardware accelerator; the first non-volatile memory storing the first encryption key; and the first secure cryptoprocessor, the hardware accelerator packaging sensor data of the one or more sensors into a first data package; the first secure cryptoprocessor encrypting the first data package; the communication interface transmits the encrypted first data package to the remote computing device; the communication interface receiving a second data package from the remote computing device; the first secure cryptoprocessor authenticating the second data package and decrypts the second data package; and the decrypted second data package being subsequently stored and executed on the hardware accelerator. In this aspect, the hardware accelerator may be a hardware AI accelerator. In this aspect, the hardware accelerator may be selected from the group consisting of a field programmable gate array (FPGA), a graphics processing unit (GPU), a tensor processing unit (TPU), a vision processing unit (VPU), and a neural processing unit (NPU). In this aspect, the communication interface may transmit the encrypted first data package to the remote computing device and the communication interface receives the second data package from the remote computing device after receiving the authentication response from the remote computing device. In this aspect, the first data package may be training or retraining data, and the second data package may be an encrypted AI model trained on the training or retraining data transmitted by the communication interface. In this aspect, the first secure cryptoprocessor may authenticate the encrypted AI model and decrypt the encrypted AI model to generate a decrypted AI model; and the decrypted AI model may be subsequently stored and executed on the hardware accelerator.

Another aspect provides a System-on-Module (SoM) device comprising one or more sensors; a communication interface; a hardware accelerator; a non-volatile memory storing an encryption key; and a secure cryptoprocessor, the hardware accelerator packaging sensor data of the one or more sensors as a first package; the secure cryptoprocessor encrypting the first package; the communication interface transmitting the encrypted first package to a remote computing device and receiving an encrypted second package; the secure cryptoprocessor authenticating the encrypted second package and decrypts the second package; and the decrypted second package being subsequently executed on the hardware accelerator. In this aspect, the hardware accelerator may be a hardware artificial intelligence (AI) accelerator. In this aspect, the hardware accelerator may be selected from the group consisting of a field programmable gate array (FPGA), a graphics processing unit (GPU), a tensor processing unit (TPU), a vision processing unit (VPU), and a neural processing unit (NPU). In this aspect, the first package may be training or retraining data, and the second package may be an encrypted AI model trained on the training or retraining data transmitted by the communication interface. In this aspect, the secure cryptoprocessor may authenticate the encrypted AI model and decrypt the encrypted AI model to generate a decrypted AI model; and the decrypted AI model may be subsequently deployed on the hardware accelerator. In this aspect, the SoM device may implement an authentication protocol to exchange data with the remote computing device via a cryptographic message derived out of unique encryption keys of a secret key pair comprising a first encryption key stored in the secure cryptoprocessor of the SoM device and a second encryption key stored in the remote computing device, and receive an authentication response from the remote computing device. In this aspect, the SoM device may implement the authentication protocol to subsequently enable an operation of the hardware accelerator of the SoM device upon receiving the authentication response, and prohibit the operation of the hardware accelerator upon not receiving the authentication response from the remote computing device.

Another aspect provides an edge computing device comprising a system-on-module (SoM) device; a secure cryptoprocessor embedded on the SoM device; a hardware accelerator embedded on the SoM device; a host device operatively coupled to the SoM device; and a processor embedded on the host device, the SoM device and the host device being enclosed within a housing. In this aspect, the hardware accelerator may be selected from the group consisting of a field programmable gate array (FPGA), a graphics processing unit (GPU), a tensor processing unit (TPU), a vision processing unit (VPU), a neural processing unit (NPU), and a hardware artificial intelligence (AI) accelerator. In this aspect, the SoM device may implement an authentication protocol to exchange data with a remote computing device via a cryptographic message derived out of unique encryption keys of a secret key pair comprising a first encryption key stored in the secure cryptoprocessor of the SoM device and a second encryption key stored in the remote computing device, and receive an authentication response from the remote computing device; and the SoM device may implement the authentication protocol to subsequently enable an operation of the hardware accelerator of the SoM device upon receiving the authentication response, and prohibit the operation of the hardware accelerator upon not receiving the authentication response from the remote computing device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

To the extent that terms “includes,” “including,” “has,” “contains,” and variants thereof are used herein, such terms are intended to be inclusive in a manner similar to the term “comprises” as an open transition word without precluding any additional or other elements.

1. An edge computing device comprising:
a first secure cryptoprocessor and a first non-volatile memory storing a first encryption key of a secret key pair, the edge computing device being configured to communicate cryptographic messages with a remote computing device comprising a second secure processor and a second non-volatile memory storing a second encryption key of the secret key pair, according to a secure communication protocol using the first and second encryption keys;
a component that is selectively disabled prior to authentication; and
a processor that is configured to send an authentication request to the remote computing device according to the secure communication protocol, and in response thereto receive an authentication response from the remote computing device, wherein the processor is configured to enable an operation of the component based on the authentication response.

2. The edge computing device of claim 1, wherein the edge computing device exchanges secure data with the remote computing device after receiving the authentication response from the remote computing device.

3. The edge computing device of claim 2, wherein the secure data includes artificial intelligence (AI) model data, AI model training or retraining data, and/or AI model analytics data.

4. The edge computing device of claim 2, wherein the secure data is encrypted by the edge computing device using the first encryption key and decrypted by the remote computing device using the second encryption key, and/or encrypted by the remote computing device using the second encryption key and decrypted by the edge computing device using the first encryption key.

5. The edge computing device of claim 1 further comprising a System-on-Module (SoM) device comprising:
one or more sensors;
a communication interface;
a hardware accelerator;
the first non-volatile memory storing the first encryption key; and
the first secure cryptoprocessor, wherein
the hardware accelerator packages sensor data of the one or more sensors into a first data package;
the first secure cryptoprocessor encrypts the first data package;
the communication interface transmits the encrypted first data package to the remote computing device;
the communication interface receives a second data package from the remote computing device;
the first secure cryptoprocessor authenticates the second data package and decrypts the second data package; and
the decrypted second data package is subsequently stored and executed on the hardware accelerator.

6. The edge computing device of claim 5, wherein the hardware accelerator is a hardware AI accelerator.

7. The edge computing device of claim 5, wherein the hardware accelerator is selected from the group consisting of a field programmable gate array (FPGA), a graphics processing unit (GPU), a tensor processing unit (TPU), a vision processing unit (VPU), and a neural processing unit (NPU).

8. The edge computing device of claim 5, wherein the communication interface transmits the encrypted first data package to the remote computing device and the communication interface receives the second data package from the remote computing device after receiving the authentication response from the remote computing device.

9. The edge computing device of claim 5, wherein the first data package is training or retraining data, and the second data package is an encrypted AI model trained on the training or retraining data transmitted by the communication interface.

10. The edge computing device of claim 8, wherein
the first secure cryptoprocessor authenticates the encrypted AI model and decrypts the encrypted AI model to generate a decrypted AI model; and
the decrypted AI model is subsequently stored and executed on the hardware accelerator.

11. A System-on-Module (SoM) device comprising:
one or more sensors;
a communication interface;
a hardware accelerator;
a non-volatile memory storing an encryption key; and
a secure cryptoprocessor, wherein
the hardware accelerator packages sensor data of the one or more sensors as a first package;
the secure cryptoprocessor encrypts the first package;
the communication interface transmits the encrypted first package to a remote computing device and receives an encrypted second package;
the secure cryptoprocessor authenticates the encrypted second package and decrypts the second package; and
the decrypted second package is subsequently executed on the hardware accelerator.

12. The SoM device of claim 11, wherein the hardware accelerator is a hardware artificial intelligence (AI) accelerator.

13. The SoM device of claim 11, wherein the hardware accelerator is selected from the group consisting of a field programmable gate array (FPGA), a graphics processing unit (GPU), a tensor processing unit (TPU), a vision processing unit (VPU), and a neural processing unit (NPU).

14. The SoM device of claim 11, wherein the first package is training or retraining data, and the second package is an encrypted AI model trained on the training or retraining data transmitted by the communication interface.

15. The SoM device of claim 14, wherein
the secure cryptoprocessor authenticates the encrypted AI model and decrypts the encrypted AI model to generate a decrypted AI model; and
the decrypted AI model is subsequently deployed on the hardware accelerator.

16. The SoM device of claim 11, wherein the SoM device implements an authentication protocol to exchange data with the remote computing device via a cryptographic message derived out of unique encryption keys of a secret key pair comprising a first encryption key stored in the secure cryptoprocessor of the SoM device and a second encryption key stored in the remote computing device, and receive an authentication response from the remote computing device.

17. The SoM device of claim 16, wherein the SoM device implements the authentication protocol to subsequently enable an operation of the hardware accelerator of the SoM device upon receiving the authentication response, and prohibit the operation of the hardware accelerator upon not receiving the authentication response from the remote computing device.

18. An edge computing device comprising:
a system-on-module (SoM) device;
a secure cryptoprocessor embedded on the SoM device;
a hardware accelerator embedded on the SoM device;
a host device operatively coupled to the SoM device; and
a processor embedded on the host device, wherein
the SoM device and the host device are enclosed within a housing.

19. The edge computing device of claim 18, wherein the hardware accelerator is selected from the group consisting of a field programmable gate array (FPGA), a graphics processing unit (GPU), a tensor processing unit (TPU), a vision processing unit (VPU), a neural processing unit (NPU), and a hardware artificial intelligence (AI) accelerator.

20. The edge computing device of claim 18,
wherein the SoM device implements an authentication protocol to exchange data with a remote computing device via a cryptographic message derived out of unique encryption keys of a secret key pair comprising a first encryption key stored in the secure cryptoprocessor of the SoM device and a second encryption key stored in the remote computing device, and receive an authentication response from the remote computing device; and
wherein SoM device implements the authentication protocol to subsequently enable an operation of the hardware accelerator of the SoM device upon receiving the authentication response, and prohibit the operation of the hardware accelerator upon not receiving the authentication response from the remote computing device.
